(19) United States
(12) Patent Application Publication
(10) Pub. No.: US 2015/0073922 A1
(43) Pub. Date: Mar. 12, 2015

(54) System and Method for Generating Customized Advertisement Creatives

(71) Applicant: MAXPOINT INTERACTIVE, INC., MORRISVILLE, NC (US)

(72) Inventors: Joseph Epperson, Cary, NC (US); Christopher Farmer, Austin, TX (US); Kurt Carlson, Austin, TX (US)

(73) Assignee: MAXPOINT INTERACTIVE, INC., MORRISVILLE, NC (US)

(21) Appl. No.: 14/020,324

(22) Filed: Sep. 6, 2013

(51) Int. Cl. G06Q 30/02

(52) U.S. Cl. CPC G06Q 30/0277
USPC 705/14.73

(57) ABSTRACT

A system and method for generating a customized advertisement creative is herein disclosed. According to one embodiment, a computer-implemented method includes receiving a uniform resource locator of a web page, detecting a plurality of assets based on a web document that describes the web page specified by the uniform resource locator, where assets of the plurality of assets are of a common asset type, ranking the assets, providing layout template settings based on a suggested asset from the ranked assets, receiving configured layout template settings, and providing a creative based on the configured layout template settings.

### FIELD

The present disclosure relates in general to the field of computer software and systems. In particular, the present disclosure relates to a system and method for generating customized advertisement creative files.

### BACKGROUND

An online advertisement generally requires an online presence such as a web page, and a production of creatives or graphic files containing images (e.g., a photo and a video) and text to described a promoted item (e.g., a product, a business, and a service). Traditionally, the production of creatives has been performed by well-trained and talented graphic designers, who tend to charge high fees for their work. This provides a burden to a cost-sensitive user (e.g., an advertiser) from experimenting with online advertising.

### SUMMARY

A system and method for generating a customized advertisement creative is herein disclosed. According to one embodiment, a computer-implemented method includes receiving a uniform resource locator of a web page, detecting a plurality of assets based on a web document that describes the web page specified by the uniform resource locator, where assets of the plurality of assets are of a common asset type, ranking the assets, providing layout template settings based on a suggested asset from the ranked assets, receiving configured layout template settings, and providing a creative based on the configured layout template settings.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying figures, which are included as part of the present specification, illustrate the various embodiments of the presently disclosed system and method and together with the general description given above and the detailed description of the embodiments given below serve to explain and teach the principles described herein.

FIG. 1 illustrates a diagram of an exemplary architecture of the present system, according to one embodiment.

FIG. 2 illustrates an exemplary screen of an editing user interface for generating a customized advertisement creative, according to one embodiment.

FIG. 3 illustrates another exemplary screen of an editing user interface for generating a customized advertisement creative, according to one embodiment.

FIG. 4 illustrates an exemplary flow chart for generating a customized advertisement creative, according to one embodiment.

FIG. 5 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for generating a customized advertisement creative is herein disclosed. According to one embodiment, a computer-implemented method includes receiving a uniform resource locator of a web page, detecting a plurality of assets based on a web document that describes the web page specified by the uniform resource locator, where assets of the plurality of assets are of a common asset type, ranking the assets, providing layout template settings based on a suggested asset from the ranked assets, receiving configured layout template settings, and providing a creative based on the configured layout template settings.

Each of the features and teachings disclosed herein can be utilized separately or in conjunction with other features and teachings to provide a system and method for generating customized advertisement creatives. Representative examples utilizing many of these additional features and teachings, both separately and in combination are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. The steps are not intended to be performed in a specific sequential manner unless specifically designated as such.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the method steps. The structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

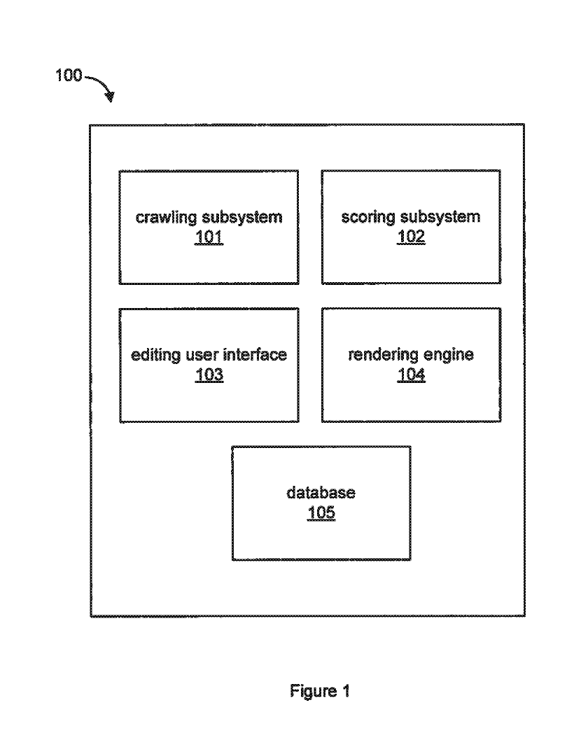

According to one embodiment, the present system and method provides an application (e.g., a web application and a mobile application) to create a customized advertisement creative by using an existing web page as a source of images and colors and generating creative files automatically. The present system and method provides a customized advertisement creative from an existing web page so that the customized advertisement creative provides a branding, look, and feel of the existing web page. FIG. 1 illustrates a diagram of an exemplary architecture of the present system, according to one embodiment. The present system 100 includes a crawling subsystem 101, a scoring subsystem 102, an editing user interface 103, a creative rendering engine 104, and a database 105. The crawling subsystem 101 gathers creative assets such as a font, a color, and an image from a web page. The scoring subsystem 102 selects and ranks the gathered assets to provide a user with suggestions regarding which assets to use. The editing user interface provides layout template settings that allows the user to select and configure the suggested assets, provide text, and preview a resulting creative The creative rendering engine 104 generates an advertisement creative and a preview of an advertisement creative from the configured layout template settings. The database 105 stores an advertisement creative and configured template settings used to generate the finalized creative for retrieval and modification for a later use.

### Crawling Subsystem

According to one embodiment, the present system includes a crawling subsystem that receives a uniform resource locator (URL) of a web page provided by a user via an editing user interface, and performs a hypertext transfer protocol (HTTP) request to load the web page specified by the URL. The crawling subsystem scans the hypertext markup language (HTML) text from the loaded web page and detects various assets associated with the web page. Such assets include, but are not limited to:
a link URL
a cascading style sheet (CSS) URL
a foreground image URL contained in an <img> HTML tag
a background image URL contained in a background CSS style
a background color
a text color
a text font

The crawling subsystem adds the detected assets (e.g., a color, a font, and an image URL) to respective lists for each asset type. The crawling subsystem further performs a HTTP request for a style sheet URL and scans the resulting HTML text of the style sheet URL to detect assets such as a background image URL, a background color, a text color, and a font. According to one embodiment, the crawling subsystem creates a list corresponding to each asset type (e.g., an image URL and associated image data, a color, and a font). The crawling subsystem further adds the detected assets that have resulted from the style sheet URL to the respective lists for each asset type. Similarly, the crawling subsystem may perform a HTTP request for a link URL, scans the resulting HTML text of the link URL to detect assets, and adds the detected assets to the respective lists for each asset type. This increases the number of web pages that provides assets. The crawling subsystem performs an HTTP request for each detected image URL and stores the resulting byte stream of the image to computer memory and an associated database. The crawling subsystem provides each list corresponding to an asset type, and data indicating the placement and attributes of each asset within the source webpage, to the scoring subsystem for analysis.

### Scoring Subsystem

According to one embodiment, the present system includes a scoring subsystem receives lists of various asset types from the crawling subsystem and processes the lists including, but not limited to, filtering, sorting, recategorizing, and flagging assets. The scoring subsystem ranks assets within each list. In one embodiment, the scoring subsystem ranks assets (e.g., a color and a font) based on how many times the asset is used within the web page, and based on an attribute of the asset. For example, the scoring subsystem gives greater weight, i.e., ranks higher an asset that has a desired proximity to a desired position within the layout of the source web page. The scoring subsystem provides a decreasing order of ranks. In another embodiment, the scoring subsystem ranks assets such as images based on scores that determine their suitability for inclusion in an advertisement, as described below. The scoring subsystem can further categorize images into logo images and background images based on a URL of the image, a size, and a position of the image within the layout of the source web page. The scoring subsystem provides an indication flag to certain images so that an image with an indication flag is ranked higher than another image without an indication flag.

According to one embodiment, the scoring subsystem processes a foreground image URL list by comparing each foreground image URL with a specified text string that is indicative of an image that is not representative of a visual appearance of a web page, such as text strings “button”, “ui-toolkit”, “icon”, and “background”. The scoring subsystem filters out or removes the foreground image URL from the foreground image URL list if the foreground image URL matches the specified text string. This allows the present system to disregard various images that are not representative of a visual appearance of a web page, such as an image library, a button, and a tool.

In another embodiment, the scoring subsystem processes a foreground image URL list by comparing each foreground image URL with a specified text string that is indicative of a non-logo image, such as a text string “bg” and a text string “background”. The scoring subsystem moves the foreground image URL to a background image URL list if the foreground image URL matches one or more of the specified text strings.

In another embodiment, the scoring subsystem processes a foreground image URL list by comparing a placement of an image that is associated with a foreground image URL within the layout of the source web page, and a HTML attribute of each foreground image URL, with a set of specified attribute that correspond to a background image. The set of specified attributes includes a placement position as specified by a display property of a CSS style sheet, a placement position within the layout of a web page, a distance from the top of a web page, a size of an image displayed on the web page, an opacity, and a z-index (a measure of the visual depth of an image). The scoring subsystem moves the foreground image URL to a background image URL list if the foreground image URL matches one or more of the specified attributes.

In another embodiment, the scoring subsystem processes a foreground image URL list by comparing each foreground image URL with a specified text string that is indicative of a logo image, such as a text string “logo”. The scoring subsystem selects a foreground image URL that matches one or more specified text strings. The scoring subsystem further determines a position of an image that is associated with a foreground image URL within the layout of the source web page and selects an image that is at a desired position (e.g., at or near the top) of the web page. The scoring subsystem provides an indication flag to the selected images, so that the corresponding foreground image URLs are ranked at the top of the foreground image URL list.

According to one embodiment, the scoring subsystem processes a background image URL list by comparing each background image URL with a specified text string such as that is indicative of images that are not representative of the web page style, such as text strings “widget”, “ui-toolkit”, “next”, and “previous” . The scoring subsystem filters out or removes the background image URL from the background image URL list if the background image URL matches the specified text strings. This allows the present system to disregard various images that are not representative of a visual appearance of a web page, such as an image library, a button, and a tool.

In another embodiment, the scoring subsystem processes a background image URL list by comparing each background image URL with a specified text string that is indicative of a logo image, such as a text string “logo”. The scoring subsystem moves the background image URL to a foreground image URL list if the background image URL matches the specified text string.

In another embodiment, the scoring subsystem processes a background image URL list by comparing a placement of an image that is associated with a background image URL within the layout of the source web page, and a HTML attribute of each foreground image URL, with a set of specified attributes that correspond to a foreground/logo image. The set of specified attributes includes a placement position as specified by the a display property of a CSS style sheet, a placement position within the layout of a web page, a distance of an image from the top of a web page, a size of an image displayed on the web page, a location of the image in the layout of the page (e.g., the image is indicated with an HTML <header> tag), an opacity, and a z-index (a measure of the visual depth of the image). The scoring subsystem moves the background URL to a foreground image URL list if the background image URL matches one or more of these specified attributes

In another embodiment, the scoring subsystem processes a background image URL list by comparing each background image URL with a specified text string that is indicative of a background image, such as a text string “bg” and a text string “background”. The scoring subsystem provides an indication flag to the background image URL so that the background image URL is ranked at the top of the background image URL list.

According to one embodiment, the scoring subsystem processes images from background image URLs and foreground image URLs by loading image data of the images into an image library and determining a height and a width of each image. The scoring subsystem calculates an aspect ratio of an image by dividing its width by its height. If the calculated aspect ratio is less than 1.0, the scoring subsystem determines an effective aspect ratio that is set to 1/aspect ratio. The effective aspect ratio provides an indication of how close an image is to being a square, with 1.0 indicating a square, and a number greater than 1.0 indicating an image that is a rectangle (e.g., a wide rectangle and a skinny rectangle). The scoring subsystem removes images that do not render well when scaled up or down to a required creative size by discarding an image that has an effective aspect ratio greater than a threshold aspect ratio, according to one embodiment. The scoring subsystem may discard an image that has a raw dimension (either height or width) that is smaller than a threshold dimension, according to another embodiment.

According to one embodiment, the scoring subsystem provides a score to each image in each list based on a scoring function that combines the effective aspect ratio, image dimensions, and a position of the image into a numerical result. An exemplary scoring function is as follows:

Score=10.0/(effective aspect ratio)+(height*width/400)−D*30,

where D is a distance of an image from the top of a web page.

The scoring subsystem sorts and ranks images according to the score and the indication flag. The scoring subsystem ranks an image with an indication flag higher than an image without an indication flag. The scoring subsystem sorts images within a set of images with indication flags according to the images' scores in descending order. Similarly, the scoring subsystem sorts images within a set of images without indication flags according to the images' scores in descending order. The scoring subsystem determines two lists of images, that includes a list of foreground images, and a list of background images, where the first image of each list indicates a best suggestion for a final advertisement creative.

According to one embodiment, the scoring subsystem sorts assets such as background colors, text colors, and fonts within each asset type list in descending order based on the total number of appearances in the source web page. The scoring subsystem generates a ranked list for each asset type, where the first element of each list indicates a best suggestion for an asset (e.g., a representative color/font) for a final advertisement creative. The scoring subsystem provides the lists to the editing user interface to generate a preview of an advertisement creative and initialize an editing function of the editing user interface.

### Editing User Interface

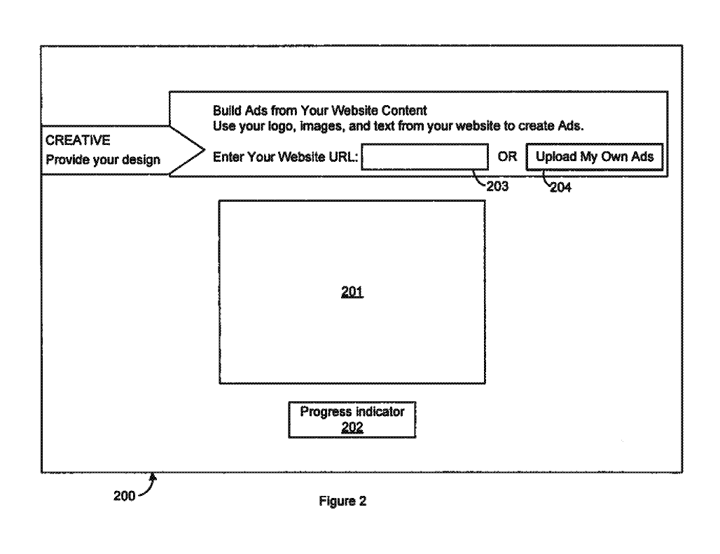

According to one embodiment, the present system includes an editing user interface that may be implemented as one or more screens that allow a user to provide a URL of a web page to be used as a source of assets (e.g., an image, a color, and a font). FIG. 2 illustrates an exemplary screen of an editing user interface for generating a customized advertisement creative, according to one embodiment. A screen 200 of an editing user interface includes a text field 203 for a user to provide a URL of a web page. The editing user interface 200 further includes an upload option 204 for a user to provide an advertisement file (e.g., a text file and an image file). The editing user interface 200 receives either the URL of a web page provided by the user or an uploaded file and provides a preview 201 of the respective web page or uploaded file. The crawling subsystem of the present system receives the URL from the editing user interface 200 and scans the web page to detect various assets. The editing user interface 200 includes a progress indicator 202 that provides an indication of the scanning progress of the crawling subsystem in real-time.

After the user provides a URL, the present system, including the crawling subsystem and the scoring subsystem receives and processes the URL and provides ranked and filtered lists of suggested assets. The editing user interface further provides a display of suggested assets, allows a user to configure the suggested assets, and allows a user to view an interim/final creative that is rendered based on the configurations.

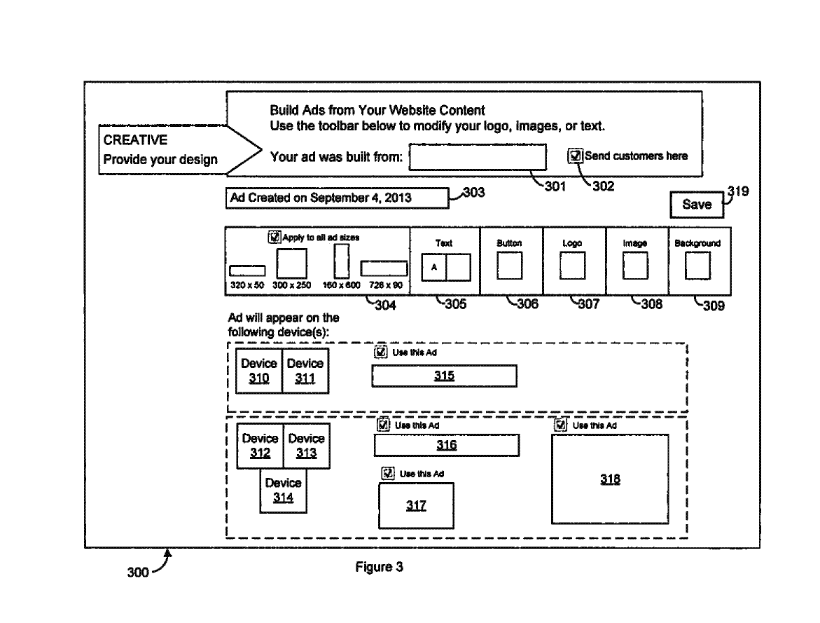

FIG. 3 illustrates another exemplary screen of an editing user interface for generating a customized advertisement creative, according to one embodiment. A screen 300 of an editing user interface includes a URL display 301 of a web page provided by a user, for example, a URL input provided in the text field 203 as illustrated in FIG. 2. The editing user interface 300 allows a user to select an option 302 that navigates other users to the URL indicated by the URL display 301 when these users select (e.g., click) an advertisement creative. The editing user interface 300 includes a date 303 that indicates a date that an advertisement creative is created.

The editing user interface 300 further includes layout template settings such as an advertisement size setting 304, a text setting 305, a button setting 306, a logo setting 307, an image setting 308, and a background setting 309. The advertisement size setting 304 includes a selection of various advertisement sizes for configuration and allows a user to apply an advertisement creative to all available advertisement sizes. The text setting 305 includes a selection of font types and font colors for configuration. The text setting 305 may include a drop down menu that provides suggested font colors from a ranked list for font colors, and other default font colors. The button setting 306 includes a selection of shapes and colors for configuration. The logo setting 307 includes a selection of suggested logo images from a ranked list for foreground image URLs. The image setting 308 includes a selection of suggested images from a ranked list for image URLs. The background setting 309 includes a selection of suggested background colors from a ranked list for background colors.

The layout template settings of the editing user interface 300 further allows a user to select a preview 319 of an advertisement creative that can be displayed on corresponding devices 310 and 311. The layout template settings of the editing user interface 300 further allows a user to select one or more previews 316-318 of advertisement creatives that can be displayed on corresponding devices 312-314. The devices 310-314 may include any type of computing devices known in the art, including but not limited to, a computer, a laptop, a tablet computer, and a mobile phone. The editing user interface 300 allows a user to provide a confirmation 319 of the configured layout template settings.

According to one embodiment, the editing user interface receives the ranked lists of suggested assets from the scoring subsystem and initializes layout template settings based on the ranked lists of suggested assets, one for each size of creative that can be served. For example, the editing user interface can initialize layout template settings for an industry standard advertisement creative size, such as 300×250 pixels. The editing user interface may provide all assets within a ranked list, or provide a number of assets from the ranked list based on a threshold. Each layout template includes a data structure that contains slots indicating the position of assets (e.g., a logo, a background image, and a text field), and a selection of an asset type (e.g., an image, a color, a font, and a text) provided by a user to fill each slot. The editing user interface allows a user to configure a position of a slot. These layout template settings, along with data indicating the total set of suggested assets available, are processed by the editing user interface's backend server and sent to the editing user interface along with the code to create and operate an editing screen of the editing user interface. The suggested assets (e.g., a font, a color, and an image) are listed in various menus of the editing user interface and the editing user interface requests an image of each advertisement creative from the creative rendering engine.

The editing user interface allows a user to select (e.g., click) a slot of each creative to perform various functions, including, but not limited to, recoloring a text field, moving an image, selecting an image from the suggested assets of the ranked lists, providing an image (e.g., by uploading an image), and editing a text within the slot. The editing user interface requests and provides an updated preview of the advertisement creative from the creative rendering engine. The editing user interface previews the changes as they are being made in place by positioning text or an image in the slot that is being configured. The editing user interface further requests an updated preview of the advertisement creative from the creative rendering engine after receiving a desired configuration of the layout template settings from the user. According to one embodiment, the editing user interface determines a required font size to fill the slot with a desired text in real time, and provide the required font size to the creative rendering engine. The editing user interface allows a user to provide cropping, scaling, and/or tiling of images.

The editing user interface receives configurations of the layout template settings provided by the user and provides the configured layout template settings to the creative rendering engine. The present system includes a server that requests a finalized advertisement creative from the creative rendering engine based on the configured layout template settings. The editing user interface stores the finalized creative, as well as the configured layout template settings used to generate the finalized creative into a database for further retrieval and configuration.

### Creative Rendering Engine

According to one embodiment, the present system includes a creative rendering engine that receives the configured layout template settings generated by the editing user interface, as well as the image data gathered by the crawling subsystem, and composites the images, colors, and text onto an image file. For example, the creative rendering engine can request a function provided by a graphic library (e.g., WINDOWS® graphics libraries). The creative rendering engine can provide a background color in the image file. The creative rendering engine provides a logo image to a desired slot, scale the logo image (without adjusting the aspect ratio) to fit in the desired slot, and center the logo image vertically and horizontally within the desired slot.

The creative rendering engine provides a background image that may or may not fill a slot of the advertisement. In one embodiment, the creative rendering engine scales down the background image to fit the advertisement slot. If the background image is smaller than the slot to be filled, the creative rendering engine tiles the background across the slot.

The creative rendering engine provides one or more text fields with various parameters, including, but not limited to, a size, a color, a content, a font, and a position, as specified in the layout template settings. The creative rendering engine provides a button image with various parameters, including, but not limited to, a color, a position, and a text, as specified in the layout template settings. The creative rendering engine provides a button image that resembles the appearance of a physical button to allow a user to select the advertisement and navigate to the advertised web page.

According to one embodiment, the creative rendering engine compresses an image file to fit within the limitations of an advertisement file server that typically mandates a maximum file size. The present system may apply lossless portable network graphics (PNG) compression to an image file, and may f apply lossy joint photographic experts group (JPEG) compression with decreasing quality levels until the resultant image is smaller than a threshold file size. In one embodiment, the threshold file size is determined based on a maximum file size provided by an advertisement file server. The editing user interface may store the generated image file in a database for export to another advertising server, or provide the generated image file to the editing user interface as part of a preview of an advertisement creative.

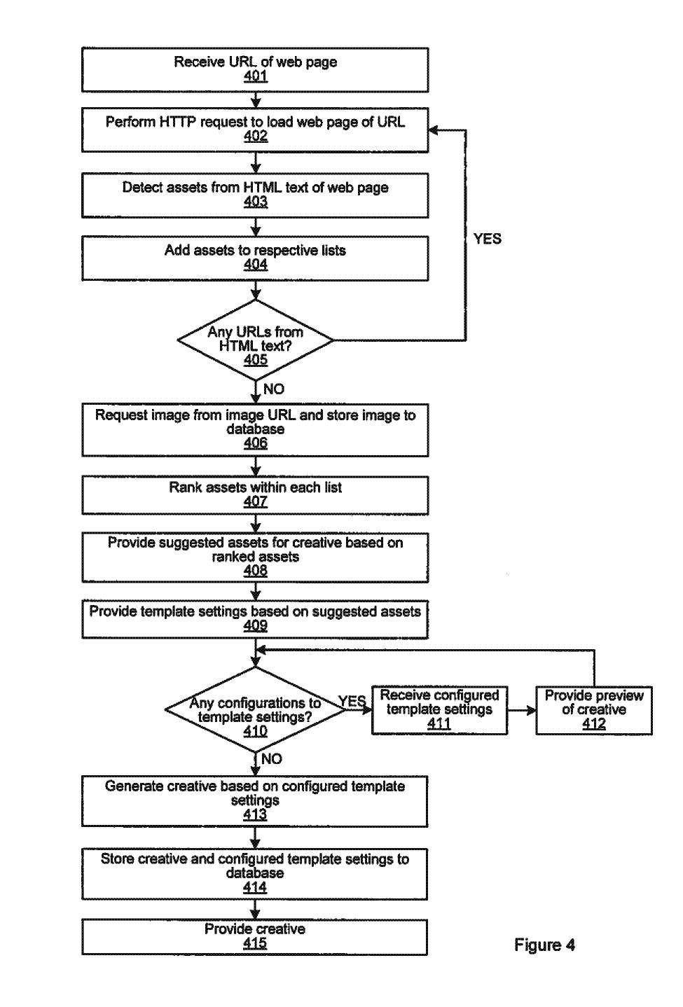

FIG. 4 illustrates an exemplary flow chart for generating a customized advertisement creative, according to one embodiment. At 401, the present system receives a URL of an advertiser's web page. At 402, the present system performs a HTTP request to load the advertiser's web page specified by the URL. At 403, the present system scans and detects assets from the HTML text of the loaded web page. At 404, the present system adds the detected assets to each respective list of a corresponding asset type. At 405, the present system determines if there are URLs within the HTML text. If there are URLs within the HTML text, the present system repeats 402-404 for each URL. If there are no more URLs within the HTML text, the present system requests and receives images from image URLs within the HTML text and stores the images to a database at 406. At 407, the present system ranks assets within each list of an asset type based on a ranking criterion. At 408, the present system provides suggested assets for an advertisement creative based on the ranked assets of each list via an editing user interface. At 409, the present system provides layout template settings for each advertisement creative based on the suggested assets. At 410, the present system determines if there are any user-provided configurations to the layout template settings. If the layout template settings are configured, the present system receives the configured layout template settings at 411, and provides a preview of the advertisement creative at 412. If the configuration of the layout template settings is completed, the present system generates an advertisement creative based on the configured template settings at 413. At 414, the present system stores the advertisement creative and configured template settings to a database. At 415, the present system provides the advertisement creative via the editing user interface.

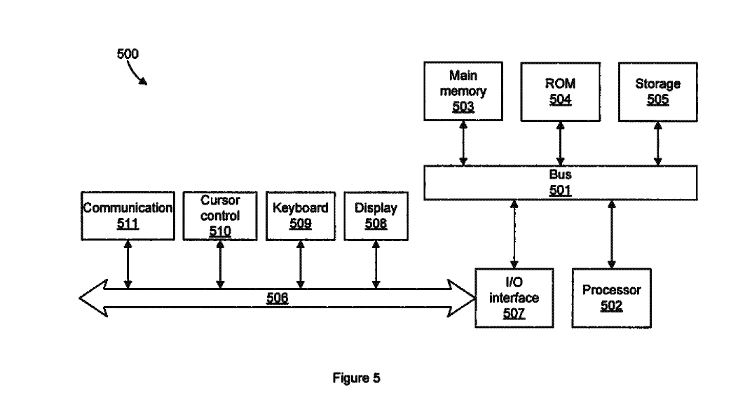

FIG. 5 illustrates an exemplary computer architecture that may be used for the present system, according to one embodiment. The exemplary computer architecture may be used for implementing one or more components described in the present disclosure including, but not limited to, the present system. One embodiment of architecture 500 includes a system bus 501 for communicating information, and a processor 502 coupled to bus 501 for processing information. Architecture 500 further includes a random access memory (RAM) or other dynamic storage device 503 (referred to herein as main memory), coupled to bus 501 for storing information and instructions to be executed by processor 502. Main memory 503 also may be used for storing temporary variables or other intermediate information during execution of instructions by processor 502. Architecture 500 may also include a read only memory (ROM) and/or other static storage device 504 coupled to bus 501 for storing static information and instructions used by processor 502.

A data storage device 505 such as a magnetic disk or optical disc and its corresponding drive may also be coupled to architecture 500 for storing information and instructions. Architecture 500 can also be coupled to a second I/O bus 506 via an 110 interface 507. A plurality of I/O devices may be coupled to I/O bus 506, including a display device 508, an input device (e.g., an alphanumeric input device 509 and/or a cursor control device 510).

The communication device 511 allows for access to other computers (e.g., servers or clients) via a network. The communication device 511 may include one or more modems, network interface cards, wireless network interfaces or other interface devices, such as those used for coupling to Ethernet, token ring, or other types of networks.

The above example embodiments have been described hereinabove to illustrate various embodiments of implementing a system and method for generating an advertisement creative. Various modifications and departures from the disclosed example embodiments will occur to those having ordinary skill in the art. The subject matter that is intended to be within the scope of the present disclosure is set forth in the following claims.

We claim:

1. A computer-implemented method, comprising:
receiving a uniform resource locator of a web page;
detecting a plurality of assets based on a web document that describes the web page specified by the uniform resource locator, wherein assets of the plurality of assets are of a common asset type;
ranking the assets;
providing layout template settings based on a suggested asset from the ranked assets;
receiving configured layout template settings; and
providing a creative based on the configured layout template settings.

2. The computer-implemented method of claim 1, wherein the assets of the plurality of assets comprises one of a link uniform resource locator, a cascading style sheet uniform resource locator, an image uniform resource locator, a background image, a foreground image, a background color, a text color, and a font.

3. The computer-implemented method of claim 1, further comprising ranking the assets from the plurality of assets based on a number of appearances of each asset on the web page.

4. The computer-implemented method of claim 3, further comprising ranking a first asset with a larger number of appearances higher than a second asset with a lower number of appearances.

5. The computer-implemented method of claim 1, further comprising ranking the assets from the plurality of assets based on a proximity of each asset to a desired position in the web page.

6. The computer-implemented method of claim 1, further comprising removing an asset from the plurality of assets based on determining that the asset is not representative of the visual appearance of the web document.

7. The computer-implemented method of claim 1, further comprising categorizing an asset of the plurality of assets to one of a foreground image list and a background image list based on a hypertext markup language element that is associated with the asset in the web page, wherein the asset comprises one of a foreground image and a background image.

8. The computer implemented method of claim 7, further comprising moving the asset to the background image list based on determining that the asset indicates the background image.

9. The computer-implemented method of claim 7, further comprising moving the asset to a foreground image list based on determining that the asset indicates a corporate logo image.

10. The computer-implemented method of claim 7, further comprising providing an indication flag to the asset based on determining that the asset indicates one of the background image and a corporate logo image.

11. The computer-implemented method of claim 10, further comprising ranking the assets from the plurality of assets based on a scoring function, wherein a first asset with a higher rank is more likely to be representative of a visual appearance of the web page than a second asset with a lower rank.

12. The computer-implemented method of claim 11 further comprising determining an aspect ratio of the asset.

13. The computer-implemented method of claim 12, further comprising setting an effective aspect ratio of the asset to an inverse of the aspect ratio based on the aspect ratio being less than one.

14. The computer-implemented method of claim 13, further comprising removing the asset from the plurality of assets based on one or more of the effective aspect ratio and the aspect ratio being greater than a threshold aspect ratio.

15. The computer-implemented method of claim 14, further comprising:
ranking a first image with the indication flag higher than a second image without the indication flag, wherein the first image and the second image are part of the plurality of assets;
ranking the first image with the indication flag and with a greater score higher than a third image with the indication flag and with a lower score, wherein the third image is part of the plurality of assets; and
ranking the second image without the indication flag and with a greater score higher than a fourth image without the indication flag and with a lower score, wherein the fourth image is part of the plurality of assets.

16. The computer-implemented method of claim 1, further comprising providing a preview of an advertisement creative based on the configured layout template settings.

17. The computer-implemented method of claim 1, wherein the layout template settings comprises a plurality of slots for configuring an asset type.

18. The computer-implemented method of claim 1, further comprising storing the creative and the configured layout template settings to a database.

19. A non-transitory computer readable medium containing computer-readable instructions stored therein for causing a computer processor to perform operations comprising:
receive a uniform resource locator of a web page;
detect a plurality of assets based on a web document that describes the web page specified by the uniform resource locator, wherein assets of the plurality of assets are of a common asset type;
rank assets from the plurality of assets;
provide layout template settings based on a suggested asset from the ranked assets;
receive configured layout template settings; and
provide a creative based on the configured layout template settings.

20. The non-transitory computer readable medium of claim 19, wherein the assets of the plurality of assets comprises one of a link uniform resource locator, a cascading style sheet uniform resource locator, an image uniform resource locator, a background image, a foreground image, a background color, a text color, and a font.

21. The non-transitory computer readable medium of claim 19, wherein the computer processor performs the operations to rank the assets from the plurality of assets based on a number of appearances of each asset on the web page.

22. The non-transitory computer readable medium of claim 21, wherein the computer processor performs the operations to rank a first asset with a larger number of appearances higher than a second asset with a lower number of appearances.

23. The non-transitory computer readable medium of claim 19, wherein the computer processor performs the operations to rank the assets from the plurality of assets based on a proximity of each asset to a desired position in the web page.

24. The non-transitory computer readable medium of claim 19, wherein the computer processor performs the operations to remove an asset from the plurality of assets based on determining that the asset is not representative of the visual appearance of the web document.

25. The non transitory computer readable medium of claim 19, wherein the computer processor performs the operations to categorize an asset of the plurality of assets to one of a foreground image list and a background image list based on a hypertext markup language element that is associated with the asset in the web page, wherein the asset comprises one of a foreground image and a background image.

26. The non-transitory computer readable medium of claim 25, wherein the computer processor performs the instructions to move the asset to a background image list based on determining that the asset indicates the background image.

27. The non-transitory computer readable medium of claim 25, wherein the computer processor performs the instructions to move the asset to a foreground image list based on determining that the asset indicates a corporate logo image.

28. The non-transitory computer readable medium of claim 25, wherein the computer processor performs the instructions to provide an indication flag to the asset based on determining that the asset indicates one of the background image and a corporate logo image.

29. The non-transitory computer readable medium of claim 28, wherein the computer processor performs the operations to rank the assets from the plurality of assets based on a scoring function, wherein a first asset with a higher rank is more likely to be representative of a visual appearance of the web page than a second asset with a lower rank.

30. The non-transitory computer readable medium of claim 29, wherein the computer processor performs the operations to determine an aspect ratio of the asset.

31. The non-transitory computer readable medium of claim 30, wherein the computer processor performs the operations to set an effective aspect ratio of the asset to an inverse of the aspect ratio based on the aspect ratio being less than one.

32. The non-transitory computer readable medium of claim 31, wherein the computer processor performs the operations to remove the asset from the plurality of assets based on one or more of the effective aspect ratio and the aspect ratio being greater than a threshold aspect ratio.

33. The non-transitory computer readable medium of claim 32, wherein the computer processor performs the operations to:
rank a first image with the indication flag higher than a second image without the indication flag, wherein the first image and the second image are part of the plurality of assets;
rank the first image with the indication flag and with a greater score higher than a third image with the indication flag and with a lower score, wherein the third image is part of the plurality of assets; and
rank the second image without the indication flag and with a greater score higher than a fourth image without the indication flag and with a lower score, wherein the fourth image is part of the plurality of assets.

34. The non-transitory computer readable medium of claim 19, wherein the computer processor performs the operations to provide a preview of an advertisement creative based on the configured layout template settings.

35. The non-transitory computer readable medium of claim 19, wherein the layout template settings comprises a plurality of slots for configuring an asset type.

36. The non-transitory computer readable medium of claim 19, wherein the computer processor performs the operations to store the creative and the configured layout template settings to a database.
